(19) United States
(12) Patent Application Publication
(10) Pub. No.: US 2026/0075077 A1
(43) Pub. Date: Mar. 12, 2026

(54) SYSTEMS AND PROCESSES FOR CRYPTOGRAPHICALLY SYNDICATING CONFIDENTIAL ALERTS IN A TRUST SERVICE MESSAGING LAYER

(71) Applicant: Prove Identity, Inc., New York, NY (US)

(72) Inventors: Nathan Soffio, JR., Philadelphia, PA (US); Oleksandr Yenkalov, Dubai Dubai (AE); Benjamin Budnevich, Larchmont, NY (US)

(21) Appl. No.: 19/327,786

(22) Filed: Sep. 12, 2025

Related U.S. Application Data
(60) Provisional application No. 63/694,058, filed on Sep. 12, 2024.

(51) Int. Cl. H04L 9/40; H04L 9/32

(52) U.S. Cl. CPC H04L 63/1433; H04L 9/3297

(57) ABSTRACT

Examples provide a process including receiving, from a first subscriber, a payload comprising an alert indicative of fraudulent activity associated with a user. The process further includes identifying, based in part on first data associated with the user and included in the payload, a second subscriber associated with the user, transmitting a request the second subscriber to provide second data associated with the user, and receiving, from the second subscriber, the second data associated with the user. The process further includes generating a comparison between one or more first fields included in the first data and one or more second fields included in the second data, and outputting results of the comparison to the second subscriber. The results are output to the second subscriber within a trust service messaging layer of an alerting network.

### CROSS-REFERENCE TO RELATED APPLICATIONS

This application claims priority to U.S. Provisional Patent Application No. 63/694,058, filed on Sep. 12, 2024, the entire content of which is incorporated herein by reference.

### BACKGROUND

One challenge associated with conventional data sharing consortiums is the inability to maintain the privacy and confidentiality of sensitive client datasets. Consortiums typically require entities to contribute personally identifiable information (PII) of clients into a centralized or shared repository. This approach raises substantial privacy and security concerns, particularly in light of increasing data protection regulation. Institutions must carefully balance the need for effective risk detection with obligations to protect client data. The risk of unauthorized access, misuse, or data leakage is amplified in such shared environments, and the potential exposure of PII may deter some institutions from participating fully or sharing complete information.

Another challenge associated with conventional data consortiums includes inconsistencies in dataset quality and reporting standards, which may undermine the effectiveness of collective risk detection. Smaller institutions may lack the resources to participate meaningfully, resulting in incomplete datasets and potential blind spots in the shared network. Further, consortiums often focus on specific types of fraud or data, limiting the scope and utility of the data consortiums. The process of reconciling conflicting datasets and managing governance across multiple contributors may also introduce delays and operational overhead, which reduces the timeliness and efficacy of risk alerting.

Conventionally, providers of many types of user-facing platforms and applications must monitor for and identify risks in isolation, without access to broader datasets. In this manner, certain types of user-facing platforms, such as small-scale platforms or those that are not explicitly regulated, cannot receive alerts about fraudulent activity or report fraudulent activity to other entities.

### SUMMARY

As the foregoing illustrates, there exists a need for a system and process that enables entities to emit and receive double-blind risk alerts regarding shared clients in a manner that preserves privacy and confidentiality of client data, complies with applicable regulatory frameworks, and overcomes the limitations of centralized data pooling. Conventional data consortiums, while providing a mechanism for information sharing, require the exposure of sensitive client and institutional information, which may create privacy risks, compliance challenges, and operational inefficiencies. These limitations may inhibit the willingness of institutions to participate fully, reduce the quality and completeness of shared data, and delay the dissemination of critical risk information.

Accordingly, examples described herein relate to a system that facilitates the real-time emission and syndication of confidential risk alerts. In some embodiments, the system uses pseudonymous identifiers and a confidential matching engine to enable privacy-preserving record linkage, to better ensure that alerts inform relevant parties without revealing reporter details or unshared identity attributes of clients. Such a solution may enable subscriber entities to determine, in a secure and cryptographically protected manner, whether other entities have a shared client relationship, and enables subscriber entities to anonymously communicate relevant risk information without disclosing personally identifiable information or proprietary business details. The disclosed examples address these needs by providing a secure messaging network that leverages secure and private communication protocols, cryptographic standards, and privacy-preserving data linkage, thereby enabling confidential and compliant risk alerting across a subscriber network.

In one independent aspect, a process includes receiving, from a first subscriber, an alert indicative of fraudulent activity associated with a user, identifying, based in part on first data associated with the user and included in the alert, a second subscriber associated with the user, requesting the second subscriber to provide second data associated with the user; receiving, from the second subscriber, the second data associated with the user; generating a cryptographic comparison between one or more first fields included in the first data and one or more second fields included in the second data, and outputting results of the cryptographic comparison to the second subscriber.

In another independent aspect, a computing system includes at least one memory storing processor-executable code, and at least one processor in communication with the at least one memory. The at least one processor is configured to execute the code to cause the at least one processor to receive, from a first subscriber, an alert indicative of fraudulent activity associated with a user, identify, based in part on first data associated with the user and included in the alert, a second subscriber associated with the user, request the second subscriber to provide second data associated with the user; receive, from the second subscriber, the second data associated with the user, generate a comparison between one or more first fields included in the first data and one or more second fields included in the second data, and output results of the comparison to the second subscriber.

In another independent aspect, a non-transitory computer readable medium stores instructions that, when executed by at least one processor, cause the at least one processor to perform a set of operations. The set of operations include receiving, from a first subscriber, an alert indicative of fraudulent activity associated with a user, identifying, based in part on first data associated with the user and included in the alert, a second subscriber associated with the user, requesting the second subscriber to provide second data associated with the user, receiving, from the second subscriber, the second data associated with the user, generating a comparison between one or more first fields included in the first data and one or more second fields included in the second data, and outputting results of the comparison to the second subscriber.

Other aspects will become apparent by consideration of the detailed description and accompanying drawings.

When compared to conventional approaches described herein in which regulated and unregulated institutions participate in data consortiums, with the disclosed techniques, a matching service can compare and detect matches of shared clients for different entities in a cryptographically protected manner and without storing or sharing PII of clients. In that regard, at least one technical advantage of the disclosed techniques relative to conventional approaches is that, with the disclosed techniques, entities can anonymously emit and receive near real time alerts in a manner that preserves the privacy of shared clients. At least another technical advantage of the disclosed techniques relative to conventional approaches is that, with the disclosed techniques, participation in the alerting system can be performed in a subscriber-based manner in which participation is not limited to only large and/or highly regulated institutions, but rather a variety of entity types.

### BRIEF DESCRIPTION OF THE DRAWINGS

FIG. 1 is a diagram of an example computing system, according to the present teachings.

FIG. 2 is a block diagram of a fraud reporting server that may be implemented in conjunction with the computing system of FIG. 1, according to the present teachings.

FIG. 3 is an example swimlane diagram for a process for generating confidential fraud alerts, according to the present teachings.

FIG. 4 is an example swimlane diagram for a process for hashing data during generation of confidential fraud alerts, according to the present teachings.

FIG. 5 illustrates an example graphical user interface (GUI) for opting-in to report suspicious activity to the fraud reporting network, according to the present teachings.

FIG. 6 illustrates an example GUI showing user information of a user with respect to a given subscriber to the fraud reporting network, according to the present teachings.

FIG. 7 illustrates an example GUI showing timeline of risk assessment events for a user with respect to a given subscriber to the fraud reporting network, according to the present teachings.

FIG. 8 is a flow diagram of process steps for generating fraud alerts, according to the present teachings.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and process components have been represented where appropriate by conventional symbols in the drawings, showing details that are pertinent to understanding the examples of the present disclosure so as not to obscure the disclosure with details that will be readily apparent to those of ordinary skill in the art having the benefit of the description herein.

### DETAILED DESCRIPTION

Examples are herein described with reference to flowchart illustrations and/or block diagrams of processes, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a special purpose computer or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The processes set forth herein need not, in some examples, be performed in the exact sequence as shown and likewise various blocks may be performed in parallel rather than in sequence.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

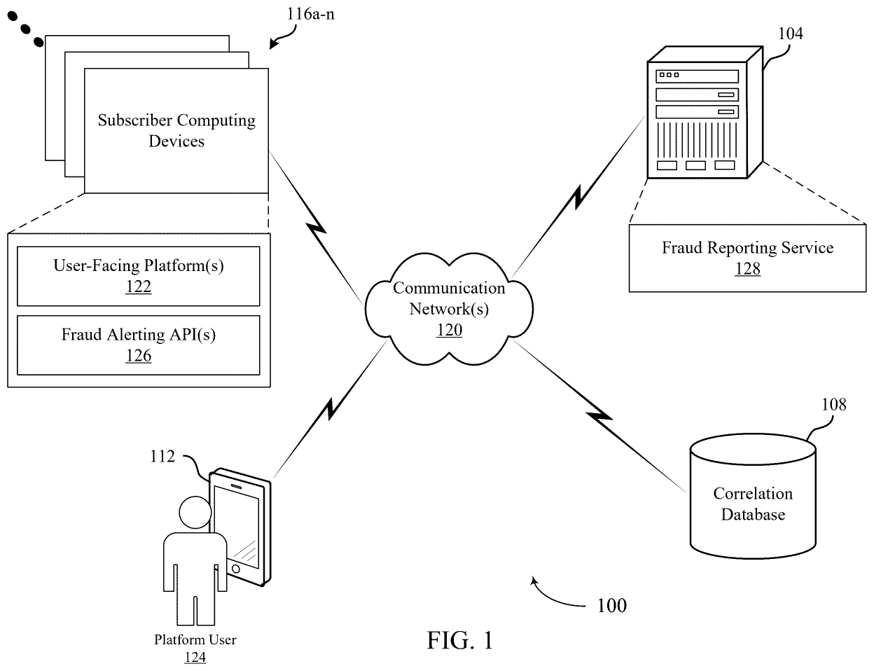

Referring now to FIG. 1, shown is an example computing system 100, according to the present teachings. As shown, the computing system 100 includes a fraud reporting server 104, a user correlation database 108, at least one user computing device 112, and a plurality of subscriber computing devices 116a-n, each of which are connected via a communications network 120.

In the embodiment shown in FIG. 1, each subscriber computing device 116 provides or is associated with at least one user-facing platform 122. Each user-facing platform 122 can include, for example, a banking platform, a brokerage platform, another type of financial services platform, a marketplace platform, a gig economy platform, and/or other types of platforms.

A user 124 of the user computing device 112 can be a user, or client, of one or more of the user-facing platforms 122 provided by or otherwise associated with one or more of the subscriber computing devices 116a-n. In that regard, the user computing device 112 can interact with the user-facing platform 122 of a subscriber computing device 116 via the communication network 120. In some instances, the user computing device 112 is used to share personally identifiable information (PII) of the user 124 when interacting with a user-facing platform 122. For example, the user computing device 112 can share PII of the user 124 during a registration process with the user-facing platform 122, or during other interactions with the user-facing platform 122. In some examples, PII shared by the user computing device 112 via a given user-facing platform 122 is stored by or otherwise accessible to the subscriber computing device 116 associated with the given user-facing platform.

The fraud reporting server 104 can be adapted to provide a fraud reporting service 128. The subscriber computing devices 116a-n can be adapted to monitor for potentially fraudulent activity associated with users of corresponding user-facing platforms 122. Each subscriber computing device 116 can be communicatively connected to the fraud reporting server 104 via the communication network 120 to emit and/or receive alerts related to suspicious or otherwise fraudulent activity associated with users of respective user-facing platforms 122. In that regard, each subscriber computing device 116 can represent a node in a fraud reporting or alerting network maintained by the fraud reporting service 128. Interactions between the subscribers to the fraud reporting network and the server 104 may be performed within a trust service messaging layer. In some examples, each subscriber computing device 116 can opt-in to the fraud reporting service 128 as an alert emitter, an alert subscriber, or both.

Each subscriber computing device 116 can include one or more alerting application programming interfaces (APIs) 126 that enable the subscriber computing device 116 to emit and/or receive alerts to and from the fraud reporting server 104. Each alert transmitted by the fraud reporting server 104 to a subscriber computing device 116 can relate to potentially fraudulent activity associated with a platform user in common with at least another subscriber computing device 116. In that regard, for a given instance of potential fraud associated with a user 124, the fraud reporting server 104 does not emit an alert to every subscriber computing device 116. Rather, the fraud reporting server 104 emits an alert only to the subscriber computing devices affiliated with the user 124.

As will be described in more detail below, the fraud reporting service 128 can identify which subscribers are affiliated with the user 124 using the correlation database 108. For example, a fraud alert received from a subscriber computing device 116 can include a user identifier (ID) that anonymously identifies the user 124 with respect to the alerting subscriber computing device 116. Each subscriber affiliated with the user 124 can store a different subscriber-specific user ID to anonymously identify the user 124 to the fraud reporting service 128. The fraud reporting service 128 can store, in the correlation database 108, a global ID of the user 124 to which the different subscriber-specific user IDs are mapped. The fraud reporting service 128 can therefore identify a global ID of the user 124 based on a first subscriber-specific user ID received in a fraud alert, identify other subscribers affiliated with the user 124 based on the identified global ID, and identify subscriber-specific user IDs of the user 124 associated with the identified other subscribers. In this manner, the fraud reporting service 128 can determine which subscribers should receive alerts about the user 124, and can propagate alerts to the identified subscribers.

Persons skilled in the art will understand that although specific functions are primarily described herein with respect to the fraud reporting server 104, in some examples, one or more functions can be performed by other components of the computing system 100.

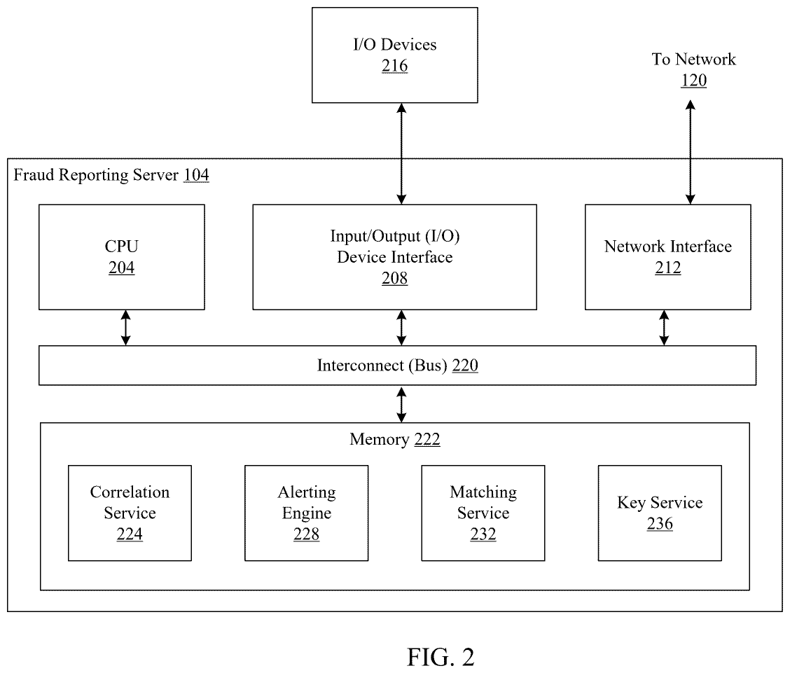

FIG. 2 is a block diagram of a fraud reporting server 104 that may be implemented in conjunction with the computing system 100 of FIG. 1, according to the present teachings. As described herein, the fraud reporting server 104 can receive an alert from a subscriber computing device 116 related to suspicious activity of a user. The fraud reporting server 104 may identify, based on received alerts, other subscribers for which the user is a shared client. The fraud reporting server 104 propagates the alert to the identified other subscribers in a manner that preserves the privacy of identifying information (e.g., PII) of the user.

In the embodiment shown, the fraud reporting server 104 includes, without limitation, a central processing unit (CPU) 204, an input/output (I/O) devices interface 208, a network interface 212, I/O devices 216, an interconnect 220, and memory 222. The CPU 204 is configured to retrieve and execute programming instructions, such as a correlation service 224, an alerting engine 228, and a payload matching service 232 stored in the memory 222. Similarly, the CPU 204 is configured to store application data (e.g., software libraries) and retrieve application data from the memory 222. The interconnect 220 is configured to facilitate transmission of data, such as programming instructions and application data, between the CPU 204, I/O devices interface 208, the network interface 212, and the memory 222. The I/O devices interface 208 is configured to receive input data from I/O devices 216 and transmit the input data to the CPU 204 via the interconnect 220. For example, I/O devices 216 may include one or more buttons, a keyboard, a mouse, and/or other input devices. The I/O devices interface 208 is further configured to receive output data from the CPU 204 via the interconnect 220 and transmit the output data to the I/O devices 208.

The memory 222 may be provided in the form of a single memory unit or multiple memory units and may be one or more articles of manufacture and/or machine components. The memory 222 may include static memory, dynamic memory, or both in communication. In some examples, the memory 222 may be one or more tangible storage mediums that can store data and executable instructions and may be non-transitory during the time instructions are stored therein. The memory 222 includes a correlation service 224, an alerting engine 228, a payload matching service 232, and key service 236, which can together form a fraud reporting service (e.g., the fraud reporting service 128 of FIG. 1).

As described above, the server 104 can receive (e.g., via the communications network 120) an initial fraud alert from a first subscriber regarding suspicious activity of a user. A payload of the initially received fraud alert can include a subscriber-specific user ID that anonymously identifies the user to the first subscriber. The correlation service 224 can identify other subscribers with which the user is affiliated based at least in part on the subscriber-specific user ID. In some examples, the correlation service 224 maps the subscriber-specific user ID included in the initially received alert to a global ID of the user. The correlation service 224 can map the global ID of the user to one or more other subscriber-specific user IDs that anonymously identify the user with respect to the other subscribers for which the user is a common client. In that regard, the correlation service 224 can interface with a database, such as the correlation database 108 of FIG. 1, storing subscriber-specific user IDs of various users and global IDs of various users. In some examples, the correlation database 108 further stores, and the correlation service 224 further identifies, a subscriber ID that identifies each subscriber to the fraud reporting network. In some examples, the subscriber IDs stored in the correlation database 108 are anonymous IDs of the subscribers, such that identifying information of the subscriber entities remain confidential.

The alerting engine 228 can receive the initial fraud alert from the first network subscriber, interact with the correlation service 224 to identify other subscribers having a shared user base with the first subscriber, and propagate the fraud alert to the identified other subscribers based at least in part on the initially received alert. Respective alerts transmitted by the alerting engine 228 can include the subscriber-specific user ID for respective subscribers receiving the alerts.

The alert initially received by the alerting engine 228 from the first subscriber can include user data fields associated with the user for which suspicious activity is detected. The user data fields can include PII of the user, such as a name of the user, an address of the user, a phone number of the user, an email address of the user 124, a date of birth of the user, at least a portion of a national identifier number (e.g., a social security number) of the user, or combinations thereof. In some examples, the user data received in the initial alert is hashed user data, as will be described in greater detail below.

The alerts propagated by the alerting engine 228 can include a request for user data associated with the shared user. The alerting engine 228 can receive, as a response, a user data snapshot from each subscriber for which an alert is propagated. The user data snapshot can include user data fields associated with the user. In some examples, the user data snapshot includes hashed user data, as will be described in greater detail below.

As will be described in greater detail below, the alerting engine 228 can communicate with the matching service 232 to match user data received in the initial alert with user data received from the other subscribers. In some examples, the matching service 232 performs field matching on hashed user data field values, for example using the key service 236. The matching service 232 can output a match report to each subscriber for which the user is a client in common.

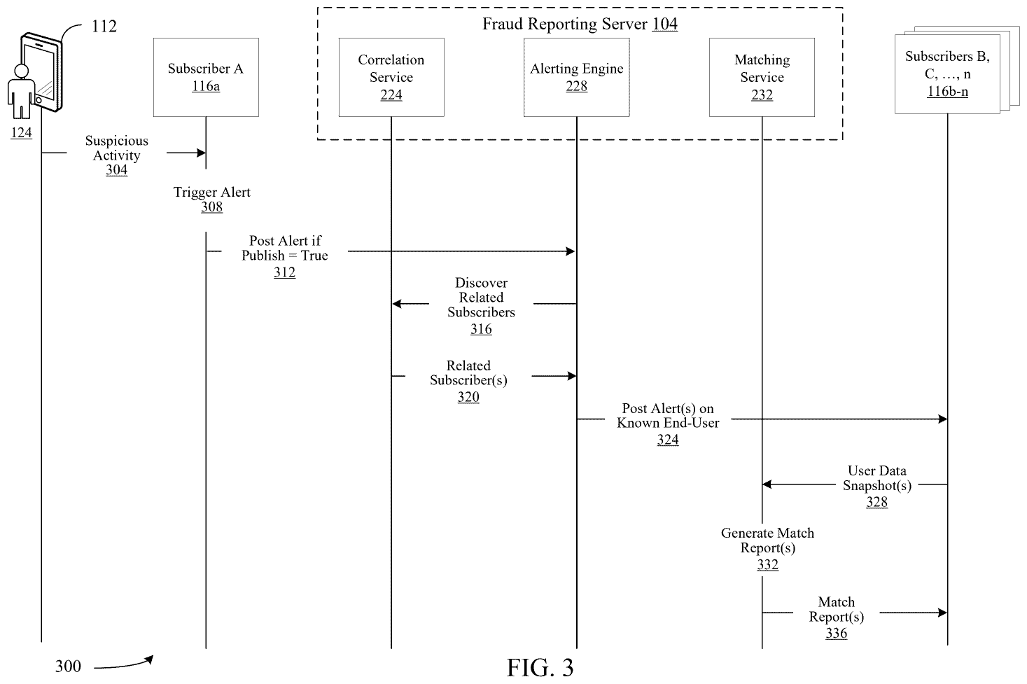

FIG. 3 is an example swimlane diagram for a process 300 for generating confidential fraud alerts, according to the present teachings. Although the interaction between the devices in process 300 are shown in an order, persons skilled in the art will understand that the interactions may be performed in a different order, interactions may be repeated or skipped, and/or may be performed by components other than those described in FIG. 3. Further, persons skilled in the art will understand that one or more operations described with respect to FIG. 3 may be performed using a different component of the computing system 100.

In some examples, the process 300 follows a publish-subscribe messaging pattern in which a reporter entity (e.g., Subscriber A corresponding to a subscriber computing device 116a) pushes a fraud risk alert to the fraud reporting server 104, and relying entities (e.g., Subscribers B, C, . . . , n corresponding to subscriber computing devices 116b-n) receive fraud risk alerts from the server 104. The fraud reporting server 104 propagates fraud risk alerts as a class of messages in a trust service messaging layer to some or all of the subscriber computing devices 116b-n. The fraud reporting server 104 determines eligibility of a subscriber computing device to receive the messages based on each subscriber's knowledge of different types of identifying information of a shared client. In some instances, the server 104 implements message queuing functionality to emit fraud risk reporting messages to eligible subscribers 116b-n. In this manner, alerting can scale, for example, according to staged-driven-event-architecture (SEDA) best practices.

At step 304, Subscriber A detects suspicious activity associated with a user 124 of a user computing device 112, the user 124 being a client or customer of a user-facing platform or service provided by Subscriber A. At step 308, Subscriber A may trigger a fraud alert associated with the suspicious activity of the user 124.

At step 312, Subscriber A publishes the alert to the server 104 if, for example, Subscriber A is opted-in as an alert reporter. In that regard, at step 312, the alerting engine 228 can receive the alert from Subscriber A related to the suspicious activity of the user 124. The alert received by the alerting engine 228 from Subscriber A can include, for example, a timestamp of the suspicious activity, a classification of the suspicious activity or reason for the alert, a subscriber-specific user ID of the user 124, and a set of user data fields corresponding to identifying information of the user 124.

The classification of the suspicious activity can include, for example, stolen identity, synthetic fraud, account takeover, or combinations thereof. A stolen identity classification may result from a determination that user data of the user 124 is different from an original know your customer (KYC) submission. A synthetic fraud classification may result from a determination that user data of the user 124 is comprised of fabricated information. An account takeover classification may result from a determination that an account of the user 124 has been compromised.

The user data fields can include, for example, a name of the user 124, an address of the user 124, a phone number of the user 124, an email address of the user 124, a date of birth of the user 124, at least a portion of a national identifier number (e.g., a social security number) of the user 124, or combinations thereof. Some or all of the content included in the alert received by the alerting engine 228 can be hashed data. In some examples, only the values of the user data fields are hashed.

At step 316, the alerting engine 228 can request, from the correlation service 224, identification of related subscribers for which the user 124 is a client in common. In some examples, the request output by the alerting engine 228 at step 316 includes the subscriber-specific user ID included in the alert received at step 312. In some examples, the subscriber-specific user ID is alternatively referred to as a correlation ID.

At step 320, the alerting engine 228 can receive, from the correlation service 224, an indication of the related subscribers for which the user 124 is a client in common. In some examples, the alerting engine 228 receives subscriber identifiers of the related subscribers as well as subscriber-specific user IDs that anonymously identify the user 124 with respect to each of the related subscribers. In the illustrated examples, the related subscribers for which the user 124 is a client in common include Subscribers B, C, . . . , n.

At step 324, the alerting engine 228 can post respective alerts to each of the identified related Subscribers B, C, . . . , n. Each alert can include, for example, the subscriber-specific user ID associated with the user 124 for that subscriber. The alerts transmitted by the alerting engine 228 to each of these Subscribers B, C, . . . , n do not indicate which other subscribers receive the alert. The alerts transmitted by the alerting engine 228 to each of the Subscribers B, C, . . . , n do not indicate which subscriber initially reported the suspicious activity. In some examples, each alert includes the timestamp of the detected suspicious activity and/or the classification of the suspicious activity. In some examples, each alert transmitted by the alerting engine 228 to the Subscribers B, C, . . . , n includes a request for user data from the respective Subscribers B, C, . . . , n.

At step 328, the matching service 232 may receive user data snapshots from some or all of the Subscribers B, C, . . . , n. In some examples, the user data snapshots include a request for a user data match report associated with the alert. The user data snapshots can include a set of user data fields corresponding to identifying information of the user 124. The user data fields can include, for example, a name of the user 124, an address of the user 124, a phone number of the user 124, an email address of the user 124, a date of birth of the user 124, at least a portion of a national identifier number of the user 124, or combinations thereof. In some examples, user data field values included in user data snapshots received from the Subscribers B, C, . . . , n are hashed.

User data fields included in the user data snapshots received from the Subscribers B, C, . . . , n can be the same or different from one another. User data fields included in the user data snapshots received from the Subscribers B, C, . . . , n can be the same or different from the user data fields received in the alert from Subscriber A at step 312. As an example, user data received from Subscriber A at step 312 may include fields for name of the user 124, phone number of the user 124, and address of the user 124. In contrast, the user data received from Subscriber B at step 328 may include fields for name of the user 124, a phone number of the user 124, and a date of birth of the user 124.

User data field values included in the user data snapshots received from the Subscribers B, C, . . . , n can be the same or different from one another. User data field values included in the user data snapshots received from the Subscribers B, C, . . . , n can be the same or different from the user data field values received in the alert from Subscriber A at step 312. As an example, a name of the user 124 indicated in a user data field received from Subscriber A at step 312 may be different from the name of the user 124 indicated in a user data field received from Subscriber B at step 328.

At step 332, the matching service 232 can generate respective match reports for each of the Subscribers B, C, . . . , n that transmitted user data snapshots to the server 104. Each match report indicates whether fields included in the user data snapshot for respective Subscribers B, C, . . . , n match corresponding fields of the user data included in the alert received from Subscriber A at step 312. The matching service 232 can generate the match reports according to least privilege with respect to the user data fields included in the alert received from Subscriber A at step 312. In that regard, the matching service may generate a match report for Subscriber B that indicates only whether user data fields included in the user data snapshot from Subscriber B have a match with corresponding user data fields from Subscriber A. As an example, user data included in the alert received from Subscriber A at step 312 may include the field-value pairs of {name: “Jonathan Q. Miller”, phone number: “555-123-4567”, address: “123 Main Street”}. User data included in the user data snapshot received from Subscriber B at step 328 may include the field-value pairs of {name: “Jon Miller”, phone number: “555-123-4567”, date of birth: “Mar. 1, 1982”}. In such an example, the match report generated by the matching service 232 for Subscriber B may indicate {name: false, phone number: true, date of birth: null}. In this manner, pairwise matches are double-blind such that the matching service 232 does not reveal to Subscriber B the user data fields or values associated with user 124 for which Subscriber B would otherwise not be privileged to. In some examples, where a field included in the user data snapshot from Subscriber B does not share a corresponding field with the user data received from Subscriber A, the matching service 232 does not indicate “null”, but rather indicates no match (e.g., “false” or “no”) for that field. In some examples, each match report is output as an array indicating matched an unmatched fields of a respective user data snapshot.

The matching service 232 can generate a match report for each of Subscribers B, C, . . . , n that indicates matches of the field-value pairs of included in the user data snapshot from respective ones of Subscribers B, C, . . . , n against the field-value pairs included in the alert received from Subscriber A at step 312. In some examples, the comparison and matching performed at step 332 by the matching service 232 is a comparison of hashed user data values, such that user data received from different subscribers is not comingled.

At step 336, the matching service 232 can output the respective match reports to the Subscribers B, C, . . . , n. In some examples, the match reports output by the server 104 at step 336 are included as part of final alert objects transmitted to respective Subscribers B, C, . . . , n. The final alert object can include, for example, a timestamp associated with transmission of the final alert object, a timestamp associated with the detection of suspicious activity of the user 124, a reason and/or classification of the alert, an indication of matched user data fields, an indication of unmatched user data fields, or combinations thereof.

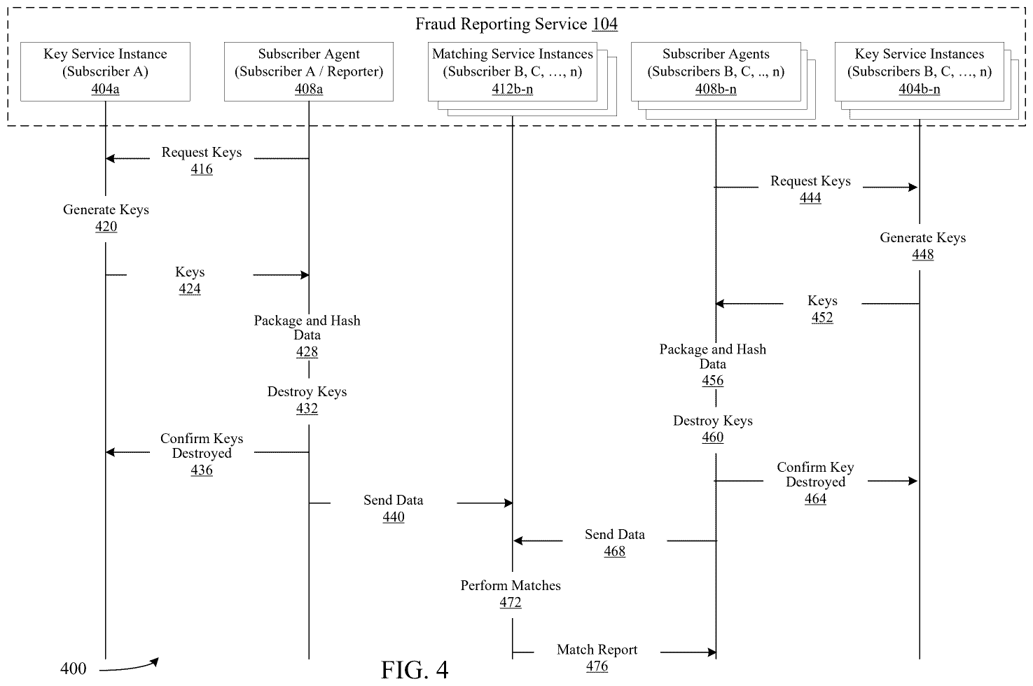

FIG. 4 is an example swimlane diagram for a process 400 for hashing data during generation of confidential fraud alerts, according to the present teachings. In some examples, operations performed in the process 400 are performed as part of match report generation at step 332 of the process 300.

Although the interaction between the devices in process 400 are shown in an order, persons skilled in the art will understand that the interactions may be performed in a different order, interactions may be repeated or skipped, and/or may be performed by components other than those described in FIG. 4. Further, persons skilled in the art will understand that one or more operations described with respect to FIG. 4 may be performed using a different component of the computing system 100.

In the example of FIG. 4, the fraud reporting server 104 can include a key service instance 404 for each subscriber and reporter to the fraud reporting network, an agent 408 for each subscriber and reporter entity to the fraud reporting network, and a matching service instance 412 for each subscriber that is to receive a fraud alert related to a client-in-common with a reporter entity. In this embodiment, key service instance 404a is key service for Subscriber A, and subscriber agent 408a is a subscriber agent for Subscriber A. In various embodiments, key service instances 404b-n are key service instances for Subscribers B, C, . . . , n. Subscriber agents 408b-n are a subscriber agents for Subscribers B, C, . . . , n. In at least one embodiment, matching service instances 412b-n are instances of a multi-instantiable matching service for Subscribers B, C, . . . , n. In some examples, the key service instances 404a-n are, or include aspects of, the key service 236 of FIG. 2. In some examples, the subscriber agents 408a-n are, or include aspects of, the alerting engine 228 of FIG. 2. In some examples, the matching service instances 412b-n are, or includes aspects of, the matching service 232 of FIG. 2. In some aspects, generating respective matching service instances for each subscriber that requests a match report enables the system to better ensure data security and privacy by preventing the comingling of client data received from the different subscribers.

At step 416, subscriber agent 408a requests at least one hashing key from the key service instance 404a. The subscriber agent 408a may request the hashing key responsive to the server 104 receiving a user data snapshot or a request for user data matching (e.g., at step 328 of the process 300) from a subscriber (e.g., Subscribers B, C, . . . , n) having a client-in-common with Subscriber A. In some examples, the subscriber agent 408a requests n-many hashing keys corresponding to n-many subscribers that requested match reports (e.g., at step 328 of the process 300). In this manner, the subscriber agent 408a can encode user data received in the alert from Subscriber A (e.g., received at step 312 of the process 300) n-many times for respective Subscribers B, C, . . . , n.

At step 420, the key service instance 404a generates n−1 many hashing keys, corresponding to the total number of subscribers that are to receive a match report. At step 424, the key service instance 404a outputs the generated keys to the subscriber agent 408a.

At step 428, the subscriber agent 408a packages the user data received from Subscriber A into n−1 many packages, and hashes (e.g., one-way hashes) the respective user data packages using the respective keys received from the key service instance 404a. While hashes are described herein by way of examples, other security protocols are also contemplated.

At step 432, the subscriber agent 408a destroys the keys, and at step 436, the subscriber agent 408a outputs a confirmation of the key destruction to the key service instance 404a. At step 440, the subscriber agent 408a outputs the respectively hashed user data packages to respective matching service instances 412b-n.

At step 444, the subscriber agents 408b-n request respective keys from corresponding key service instances 404b-n. The subscriber agents 408b-n may request the hashing keys responsive to the server 104 receiving corresponding user data snapshots or a requests for user data matching (e.g., at step 328 of the process 300) from the corresponding subscribers (e.g., Subscribers B, C, . . . , n) having a client-in-common with Subscriber A. In some examples, each subscriber agent of the subscriber agents 408b-n requests one key. The keys generated by the key service instances 404b-n may correspond to respective keys generated by the key service instance 404a for encrypting user data received by the server 104 from Subscriber A. In this manner, each subscriber agent of the subscriber agents 408b-n can each encode corresponding user data from Subscribers B, C, . . . , n for comparison against user data received by the server 104 from Subscriber A.

At step 448, the key service instances 404b-n generate respective hashing keys for corresponding subscriber agents 408b-n. At step 452, the key service instances 404b-n output the generated keys to the corresponding subscriber agents 408b-n.

At step 456, the subscriber agents 408b-n package the user data respectively received from Subscribers B, C, . . . , n into corresponding packages, and hash (e.g., one-way hashes) the corresponding user data packages using the respective keys received from the respective key service instances 404b-n.

At step 460, the subscriber agents 408b-n destroy the keys, and at step 464, the subscriber agents 408b-n output confirmations of the key destruction to the respective key service instances 404b-n. At step 464, the subscriber agents 408b-n output the respectively hashed user data packages to corresponding matching service instances 412b-n.

At step 468, the subscriber agents 408b-n output the respectively hashed user data packages to corresponding matching service instances 412b-n.

At step 472, each matching service instance performs deterministic matching with respect to a hashed data package received from the subscriber agent 408a (e.g., corresponding to user data received from Subscriber A) and a hashed data packaged received from a respective one of the subscriber agents 408b-n (e.g., corresponding to user data received from one of Subscribers B, C, . . . , n). The matching service instances 412b-n perform respective comparisons of hashed fields in user data packages received from the subscriber agent 408a with hashed fields in user data packages received from corresponding subscriber agents 408b-n. In this manner, the different matching service instances 412b-n do not compare or comingle unencrypted user data with one another or with subscriber agents 408a-n.

At step 476, the matching service instances 412b-n output respective match reports to corresponding subscriber agents 408b-n. The payload of each match report can include a nullable set of matching fields and a nullable set of unmatching fields.

In some examples, the subscriber agents 408b-n assemble final alert objects for respective ones of the Subscribers B, C, . . . , n that include the corresponding match reports. The subscriber agents 408b-n can output the alert objects including the match reports to the corresponding subscriber devices (e.g., at step 336 of the process 300). In some examples, the alert objects are exposed to respective subscribers via an API as an alert event.

In some examples, both encrypted and unencrypted user data generated or used by components of the fraud reporting server 104 is destroyed responsive to output of the match reports to the Subscribers B, C, . . . , n. In some examples, the confidential matching service instances 412b-n are deprecated responsive to output of the match reports to the Subscribers B, C, . . . , n.

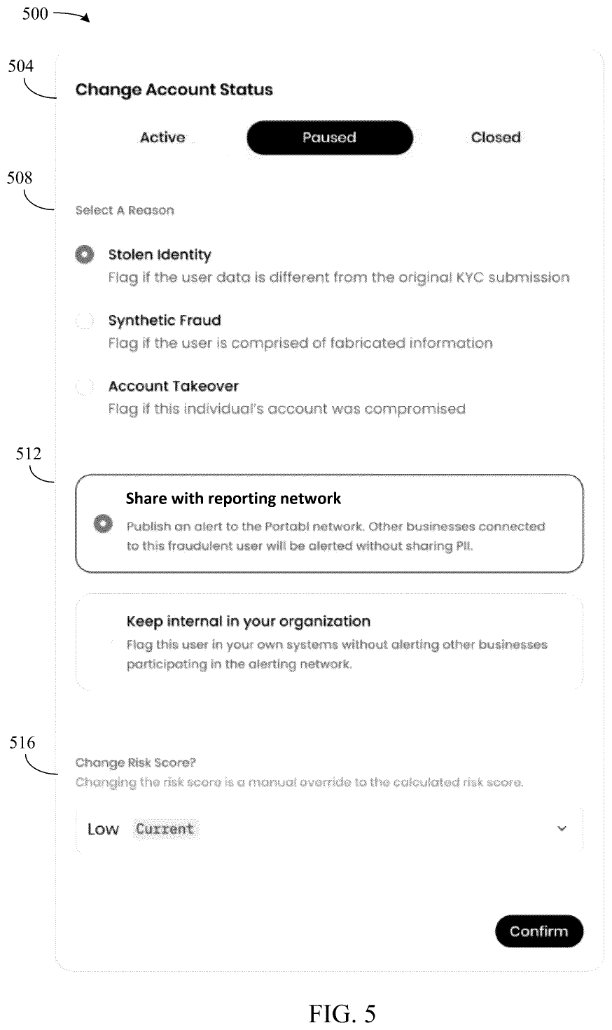

FIG. 5 illustrates an example graphical user interface (GUI) 500 for opting-in to report suspicious activity to the fraud reporting network, according to the present teachings. Aspects of the GUI 500 may be provided by the server 104 to a subscriber computing device 116 via, for example, fraud alerting APIs 126 and the communication network 120.

The GUI 500 can facilitate selection, using a subscriber computing device 116, of fraud reporting settings for different users of a platform (e.g., user-facing platform 122) provided by a given subscriber to the fraud reporting network. In the example shown, the GUI 500 includes account status settings 504, alert classification settings 508, alert publishing settings 512, and risk score settings 516.

The account status settings 504 can include selectable options to mark a user account as active, paused, or closed. In some examples, an active user account indicates that a user is anonymously registered to the fraud reporting network (e.g., having a subscriber-specific user ID stored in the correlation database 108) with respect to a given subscriber. In some examples, a paused user account indicates that a user is registered with the fraud reporting network, but that the subscriber has temporarily opted out of receiving or emitting fraud alerts related to the user via the fraud reporting server 104. In some examples, a closed user account indicates that a user is no longer registered with the fraud reporting network with respect to the given subscriber. For example, the fraud reporting server 104 can deactivate or delete a subscriber-specific user ID of the user from the correlation database 108.

The alert classification settings 508 can indicate selectable reasons, or classifications, for which a given subscriber emits alerts for a user. The alert classification settings 508 can include, for example, a stolen identity classification, a synthetic fraud classification, an account takeover classification, and/or another type of classification. A stolen identity classification may result from a determination that user data of the user 124 being different from an original know your customer (KYC) submission. A synthetic fraud classification may result from a determination that user data of the user 124 is comprised of fabricated information. An account takeover classification may result from a determination that an account of the user 124 has been compromised. While shown as radio buttons in the example GUI 500 of FIG. 5, the classification settings can alternatively be provided at check boxes, or as another multi-selectable user interface element. In that regard, multiple classifications can be selected simultaneously via the GUII 500.

In some examples, classifications of subscriber-specific alerts can be customizable or configurable according to selections received from respective subscriber computing devices. For example, the fraud reporting server 104 can receive a set of subscriber-specific classifications from a particular subscriber computing device 116 and/or a set of parameters that define each subscriber-specific classification. The subscriber-specific classifications can be stored by the server 104, or can be received by the server 104 responsive to an instance of suspicious activity associated with a client of the particular subscriber. Alerts and/or reports transmitted by the server 104 to the particular subscriber computing device 116 can therefore include an indication of the one or more subscriber-specific classifications.

The alert publishing settings 512 can facilitate selection by a subscriber computing device 116 of whether to report, or publish, alerts regarding suspicious activity of the user to the fraud reporting network via the fraud reporting server 104. For example, the alert publishing settings can include an option to share alerts with fraud reporting network and an option to alternatively keep alerts private to the internal organization associated with the given subscriber without publishing to the fraud reporting network. In this manner, the fraud reporting server 104 enables a subscriber to voluntarily opt-in or opt-out of emitting alerts regarding users, while allowing the subscriber to still receive alerts regarding those users.

The risk score settings 516 can facilitate selection by a subscriber computing device 116 to manually override a risk score associated with a user. In some examples, the risk score associated with a user is used by the subscriber computing device 116 to determine whether to emit an alert to the fraud reporting network. For example, a high-risk score can indicate a low threshold for determining whether to emit an alert, while a low-risk score indicates a high threshold for determining whether to emit an alert. While shown in the example of FIG. 5 as a risk score indicative of a level of risk associated with a user, in other examples, the risk score settings 516 are provided as trust score settings. In such examples, a trust score can be inversely related to a risk score, such that a high trust score indicates a lower risk user and a low trust score indicates a higher risk user. In some examples, an indication of the risk score or trust score associated with a user is included in alerts emitted by the subscriber computing device 116 to the fraud reporting server 104. In such examples, the fraud reporting server 104 can include the trust score or risk score in the propagated alerts emitted to the other subscribers for which the user is a client-in-common.

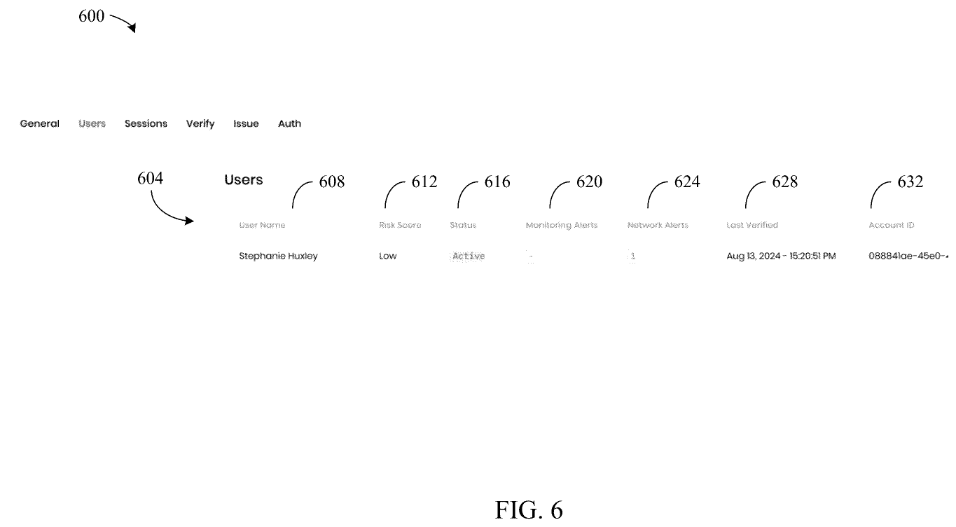

FIG. 6 illustrates an example GUI 600 showing user information 604 of a user with respect to a given subscriber to the fraud reporting network, according to the present teachings. Aspects of the GUI 600 may be provided by the fraud reporting server 104 to a subscriber computing device 116 via, for example, fraud alerting APIs 126 and the communication network 120.

In the example shown, the user information 604 includes an indication of the name 608 of the user, a risk score 612 of the user, an account status 616 of the user, an indication of monitoring alerts 620 of the user, an indication of network alerts 624 of the user, a most recent verification date 628 of the user, and an account ID 632 of the user.

The name 608 of the user can indicate a name with which the user is registered to a platform (e.g., user-facing platform 122) provided by the given subscriber.

The risk score 612 can indicate a risk score associated with the user. In some examples, the risk score 612 is a subscriber-specific risk score of the user. In other examples, the risk score 612 is a network-level risk score of the user across the fraud reporting network. In some examples, the risk score 612 is alternatively provided as a trust score of the user.

The account status 616 can indicate whether reporting and receipt of fraud alerts is enabled for the user with respect to the given subscriber. For example, the account status 616 can indicate whether an account of the user is active, paused, or closed.

The indication of monitoring alerts 620 can indicate whether the subscriber computing device 116 has detected any instances of suspicious activity associated with the user via the user-facing platform 122. The indication of monitoring alerts 620 can include, for example, a date of a most recent alert, a number of alerts, or the like.

The indication of network alerts 624 can indicate whether any network-level alerts for the user have been received by the subscriber computing device 116 from another subscriber of the fraud reporting network via the fraud reporting server 104. The indication of network alerts 624 can indicate a number of network-level alerts, a date of a most recent alert, or the like.

The most recent verification date 628 of the user can indicate a date and/or time that the user most recently underwent a verification or authentication process with, for example, the user-facing platform 122 provided by the subscriber.

The account ID 632 of the user can indicate an account ID number of the user for the user-facing platform 122 provided by the subscriber, the subscriber-specific user ID of the user for the fraud reporting network, or both.

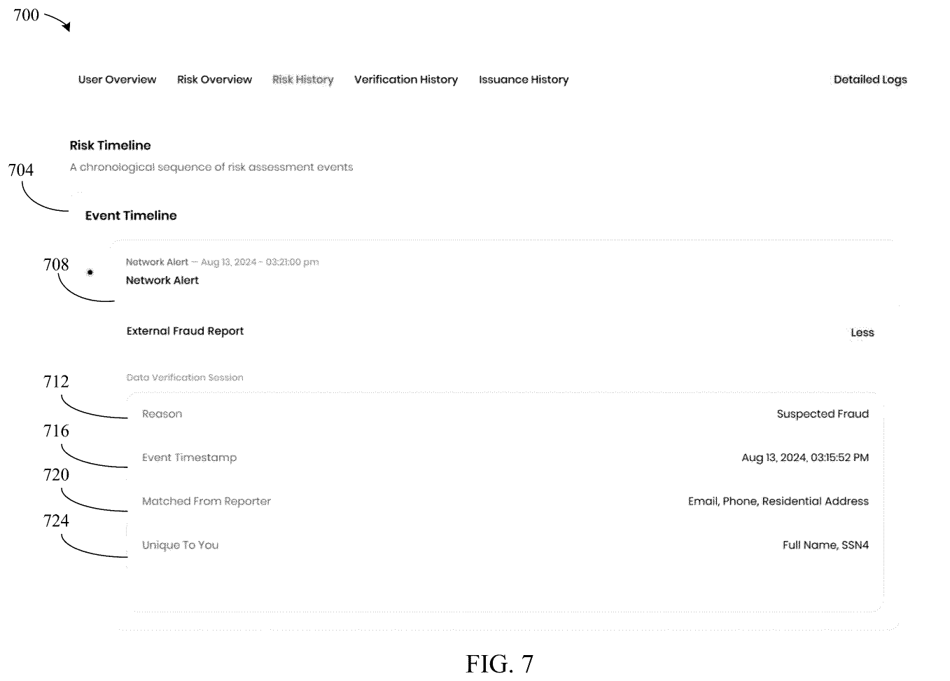

FIG. 7 illustrates an example GUI 700 showing timeline 704 of risk assessment events for a user with respect to a given subscriber to the fraud reporting network, according to the present teachings. Aspects of the GUI 700 may be provided by the fraud reporting server 104 to a subscriber computing device 116 via, for example, fraud alerting APIs 126 and the communication network 120.

In the embodiment shown, the timeline 704 includes a network alert 708 indicating that the fraud reporting server 104 has transmitted a fraud alert to the subscriber computing device 116 related to suspicious activity of the user detected by another subscriber with which the user is a client-in-common. Information included in the network alert 708 can be included in an alert transmitted by the fraud reporting server at, for example, step 312 of the process 300 and/or step 336 of the process 300. The network alert 708 can include a classification or reason 712 for the alert such as, for example, suspected fraud. The network alert 708 can include a timestamp associated with the date and/or time that the fraudulent activity of the user was initially detected or reported by the reporting subscriber to the subscriber network. The network alert 708 can include a set of matched user data fields 720, such as, for example, email address, phone number, and residential address. The network alert 708 can include a set of unmatched user data fields, such as, for example, full name and last four digits of a social security number. In some examples, the set of matched user data fields 720 and set of unmatched user data fields 724 together form a match report or match payload, such as the match report generated at step 332 of the process 300 and/or step 472 of the process 400. In some examples, the network alert 708 displayed in the GUI 700 further includes the subscriber-specific user ID of the user.

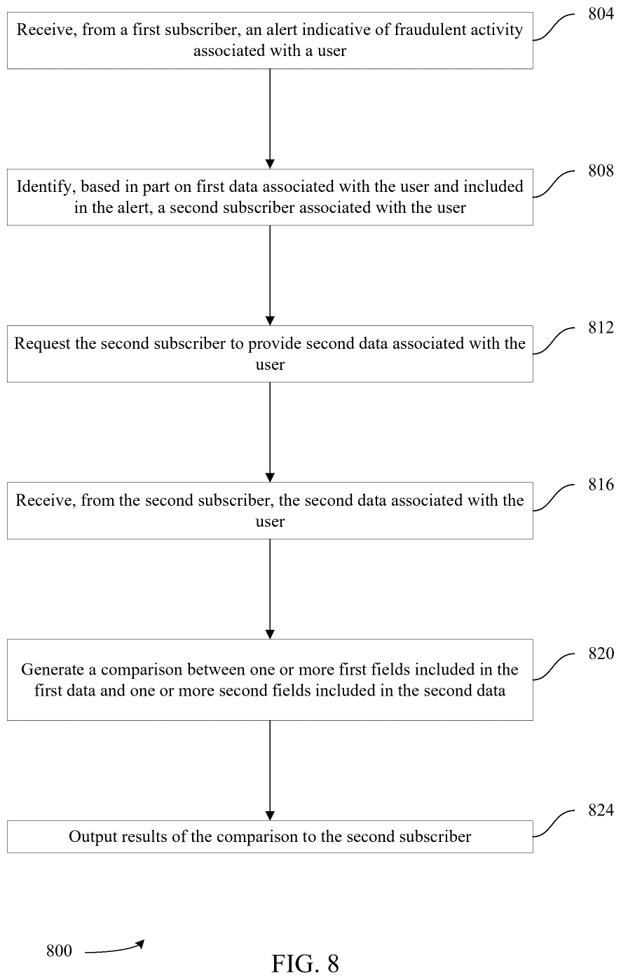

FIG. 8 is a flow diagram of process steps 800 for generating fraud alerts, according to the present teachings. Although the process steps are described with reference to the systems and processes of FIGS. 1-7, persons skilled in the art will understand that any system configured to implement the process steps, in any order, falls within the scope of the present invention.

The process steps 800 include receiving, from a first subscriber, an alert indicative of fraudulent activity associated with a user (at step 804). For example, the fraud reporting server 104 can receive an alert from a first subscriber computing device 116a indicative of fraudulent activity associated with a user 124. In some examples, the alert further includes a timestamp associated with the fraudulent activity and/or a classification associated with the fraudulent activity.

The process steps 800 include identifying, based in part on first data associated with the user and included in the alert, a second subscriber associated with the user (at step 808). In some examples, the alert can include a first identifier (e.g., a first subscriber-specific identifier) associated with the user, and identifying a second subscriber includes determining a second identifier (e.g., a second subscriber-specific identifier) associated with the user based in part on the first identifier. In some examples, the server 104 determines the second identifier associated with the second subscriber by mapping the first identifier to a global identifier associated with the user and mapping the global identifier to the second identifier.

The process steps 800 include requesting the second subscriber to provide second data associated with the user (at step 812). For example, the server 104 can transmit a request to a second subscriber (e.g., a second subscriber computing device 116b) to provide second data associated with the user 124.

The process steps 800 include receiving, from the second subscriber, the second data associated with the user (at step 816). For example, the server 104 can receive a user data snapshot from the second subscriber computing device 116b.

The process steps 800 include generating a comparison between one or more first fields included in the first data and one or more second fields included in the second data (at step 820). The one or more first fields include, for example, data of the user 124 known to the first subscriber. The one or more second fields include, for example, data of the user 124 known to the second subscriber. For example, the one or more first fields can include a name of the user 124, an address of the user 124, a phone number of the user 124, a date of birth of the user 124, at least a portion of a national identifier number of the user, or a combination thereof. The one or more second fields can include, for example, a name of the user 124, an address of the user 124, a phone number of the user 124, a date of birth of the user 124, at least a portion of a national identifier number of the user, or a combination thereof. Data included in the one or more first fields can conflict with data included in the one or more second fields.

In some examples, the comparison between the one or more first fields and the one or more second fields is performed with respect to encrypted values of the one or more first fields and encrypted values of the one or more second fields. For example, fraud reporting server 104 can receive some or all of the first data from the first subscriber computing device 116a in an encrypted format, and receive some or all of the second data from the second subscriber computing device 116b in an encrypted format. In other examples, the fraud reporting server 104 can encrypt some or all of the first data received from the first subscriber computing device 116a and encrypt some or all of the second data received from the second subscriber computing device 116b prior to performing the comparison. In some examples, the fraud reporting server 104 deletes at least one encryption key associated with the encrypted values of the one or more first fields and the one or more second fields responsive to completing the comparison.

The process steps 800 include outputting results of the comparison to the second subscriber (at step 824). For example, the server 104 can output results of the comparison to the second subscriber computing device 116b. The results of the comparison can indicate whether a first value of the one or more first fields matches a second value of the one or more second fields. As an example, the results of the comparison can indicate whether a field value of the first data corresponding to a phone number of the user 124 matches a field value of the second data corresponding to a phone number of the user 124.

The results of the comparison can indicate, the results of the comparison indicate, for each second field included in the one or more second fields, whether a value of a respective second field matches a value of a corresponding first field included in the one or more first fields. In some examples, a set of fields defined by the one or more first fields is a different than a set of fields defined by the one or more second fields. In that regard, the server 104 does not perform a comparison with respect to fields included in the first data that do not have a corresponding field included in the second data. In some examples, the results of the comparison indicate whether a field included in the one or more first second is not included in the one or more first fields. However, the results of the comparison may not indicate whether a field included in the one or more first fields is not included in the one or more second fields.

In some examples, the second identifier is output to the second subscriber. For example, the fraud reporting server 104 can output the second subscriber-specific identifier of the user 124 to the second subscriber computing device 116b prior to, after, or in conjunction with the results of the comparison.

In some examples, the timestamp associated with the fraudulent activity and/or the classification of the fraudulent activity is output to the second subscriber. For example, the fraud reporting server 104 can output the timestamp associated with the fraudulent activity and/or the classification of the fraudulent activity to the second subscriber computing device 116b prior to, after, or in conjunction with the results of the comparison.

In some examples, the first data and/or the second data is deleted responsive to outputting the results of the comparison. For example, the fraud reporting server 104 can automatically erase the user data received from the first subscriber computing device 116a and the user data received from the second subscriber computing device 116b responsive to outputting the results of the comparison to the second subscriber computing device 116b.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages or electronically encoded data, among other features and functions set forth herein). Additionally, some or all of the steps described herein may be performed automatically by the computing system without human intervention.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, article, or apparatus that comprises, has, includes, contains a list of elements does not include only those elements but may include other elements not expressly listed or inherent to such process, article, or apparatus. An element proceeded by “comprises . . . a,” “has . . . a,” “includes . . . a,” “contains . . . a” does not, without more constraints, preclude the existence of additional identical elements in the process, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, process, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the process and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a process as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This process of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A process comprising:
receiving, from a first subscriber, a payload comprising an alert indicative of fraudulent activity associated with a user;
identifying, based in part on first data associated with the user and included in the payload, a second subscriber associated with the user;
transmitting a request to the second subscriber to provide second data associated with the user;
receiving, from the second subscriber, the second data associated with the user;
generating a cryptographic comparison between one or more first fields included in the first data and one or more second fields included in the second data; and
outputting results of the cryptographic comparison to the second subscriber.

2. The process of claim 1, wherein the results of the cryptographic comparison indicate whether a first value of the one or more first fields matches a second value of the one or more second fields.

3. The process of claim 1, wherein the results of the cryptographic comparison indicate, for each second field included in the one or more second fields, whether a value of a respective second field matches a value of a corresponding first field included in the one or more first fields.

4. The process of claim 3, wherein a set of fields defined by the one or more first fields is a different than a set of fields defined by the one or more second fields.

5. The process of claim 4, wherein the results of the cryptographic comparison indicate whether a field included in the one or more first second is not included in the one or more first fields.

6. The process of claim 1, wherein:
the one or more first fields include at least one of a name of the user, an address of the user, a phone number of the user, a date of birth of the user, or at least a portion of a national identifier number of the user; and
the one or more second fields include at least one of a name of the user, an address of the user, a phone number of the user, a date of birth of the user, or at least a portion of a national identifier number of the user.

7. The process of claim 1, wherein:
the first data includes a first identifier associated with the user,
identifying the second subscriber includes determining a second identifier associated with the user based in part on the first identifier; and
the second identifier is different from the first identifier.

8. The process of claim 7, wherein determining a second identifier associated with the user includes mapping the first identifier to a global identifier associated with the user and mapping the global identifier to the second identifier.

9. The process of claim 7, further comprising:
outputting the second identifier to the second subscriber.

10. The process of claim 1, wherein the alert further includes at least one of a timestamp associated with the fraudulent activity or a classification of the fraudulent activity, and the process further comprises:
outputting the at least one of the timestamp associated with the fraudulent activity or the classification of the fraudulent activity to the second subscriber.

11. A computing system comprising:
at least one memory storing processor-executable code; and
at least one processor in communication with the at least one memory, the at least one processor configured to execute the code to cause the at least one processor to:
receive, from a first subscriber, an alert indicative of fraudulent activity associated with a user;
identify, based in part on first data associated with the user and included in the alert, a second subscriber associated with the user;
request the second subscriber to provide second data associated with the user;
receive, from the second subscriber, the second data associated with the user;
generate a comparison between one or more first fields included in the first data and one or more second fields included in the second data; and
output results of the comparison to the second subscriber.

12. The computing system of claim 11, wherein the comparison between the one or more first fields and the one or more second fields is performed with respect to encrypted values of the one or more first fields and the one or more second fields.

13. The computing system of claim 12, wherein the at least one processor is further configured to execute the code to cause the at least one processor to:
delete at least one encryption key associated with the encrypted values of the one or more first fields and the one or more second fields responsive to performing the comparison.

14. The computing system of claim 11, wherein:
the results of the comparison indicate whether a first value of the one or more first fields matches a second value of the one or more second fields.

15. The computing system of claim 11, wherein the results of the comparison indicate, for each second field included in the one or more second fields, whether a value of a respective second field matches a value of a corresponding first field included in the one or more first fields.

16. The computing system of claim 13, wherein a set of fields defined by the one or more first fields is a different than a set of fields defined by the one or more second fields.

17. The computing system of claim 14, wherein the results of the comparison indicate whether a field included in the one or more first second is not included in the one or more first fields.

18. The computing system of claim 11, wherein:
the one or more first fields include at least one of a name of the user, an address of the user, a phone number of the user, an email address of the user, a date of birth of the user, or at least a portion of a national identifier number of the user; and
the one or more second fields include at least one of a name of the user, an address of the user, a phone number of the user, an email address of the user, a date of birth of the user, or at least a portion of a national identifier number of the user.

19. The computing system of claim 11, wherein:
the first data includes a first identifier associated with the user;
identifying the second subscriber comprises determining a second identifier associated with the user based in part on the first identifier; and
the second identifier is different from the first identifier.

20. A non-transitory computer readable medium storing instructions that, when executed by at least one processor, cause the at least one processor to perform a set of operations comprising:
receiving, from a first subscriber, an alert indicative of fraudulent activity associated with a user;
identifying, based in part on first data associated with the user and included in the alert, a second subscriber associated with the user;
requesting the second subscriber to provide second data associated with the user;
receiving, from the second subscriber, the second data associated with the user;
generating a cryptographic comparison between one or more first fields included in the first data and one or more second fields included in the second data; and
outputting results of the cryptographic comparison to the second subscriber.
